(19) United States
(12) Patent Application Publication
(10) Pub. No.: US 2004/0202305 A1
(43) Pub. Date: Oct. 14, 2004

(54) Supervised call redirection

(75) Inventor: Paul M. Brennan, Toronto (CA)

Correspondence Address: DOCKET CLERK, P.O. DRAWER 800889, DALLAS, TX, 75380, US

(73) Assignee: NORTEL NETWORKS LIMITED

(21) Appl. No.: 09/735,791

(22) Filed: Dec. 14, 2000

(51) Int. Cl. H04M 3/42; H04M 7/00

(52) U.S. Cl. 379/211.04; 379/211.02

(57) ABSTRACT

A telephone system supervises the redirection of an incoming telephone call to a subscriber who is not located at their expected location. Thus, when a calling party attempts to contact a subscriber who is not at their expected location, the system initially leaves the call unanswered (i.e., ringing) while initiating one or more outgoing calls to call forwarding numbers for the subscriber. If no outgoing telephone call is answered, the system directs the incoming telephone call to the subscriber's voice mail, or to another pre-determined location (e.g., an attendant). On the other hand, if the outgoing telephone call is answered, the system answers the incoming telephone call and bridges the incoming call to the answered outgoing call.

### FIELD OF THE INVENTION

The present invention relates to call handling which may involve supervised call redirection.

### BACKGROUND OF THE INVENTION

Call redirection, or forwarding, is a feature which is offered to subscribers of telephony service. Call forwarding allows subscribers to forward their incoming telephone calls to another telephone number when they are away from their expected locations. For instance, some subscribers may use call forwarding to forward telephone calls from their homes to their cellular telephones when they are not at home. Also, some business subscribers may use call forwarding to forward telephone calls to another location when they are not at their desk.

Call forwarding is quite useful in that it allows a calling party another at reaching the subscriber. Instead of leaving a voice message which may not be retrieved for an extended period of time, the calling party may possibly contact the subscriber even when the subscriber is not at their expected location.

A drawback with many known call forwarding systems is that they are unable to access the subscriber's voice mail if the subscriber is not at the forwarding location. Indeed, if no one answers at the forwarding location, the call forwarded phone may simply ring for the duration of the call attempt or may enter a voice mail box for someone other than the subscriber. This may force the caller to hang up, place a further call to an attendant, and request connection to the subscriber's voice messaging system.

Where the telephone system is a private branch exchange (PBX), a further possible drawback is that the system may complete an incoming call before forwarding the call. This results in the prospect of the caller being charged for a long distance call during which the caller was presented only with ringing signals (first from the telephone network and then from the PBX). Furthermore, even where the telephone system resides on the network side, some jurisdictions permit a call to be billed after a certain number of rings (e.g., three). A call forwarding scheme which forwards a call after a set number of rings will often result in the minimum number of rings for billing being exceeded before a caller realises his call will remain unanswered.

In some known call redirection systems, prior to call forwarding, a voice message is provided to the calling party to inform them that they are being forwarded to another number. A drawback with this operation is that it results in an extra delay for the caller while he listens to the messages.

Therefore, there remains a need for a call forwarding approach which avoids at least some of the noted problems.

### SUMMARY OF THE INVENTION

With the present invention, a telephone system supervises the redirection of an incoming telephone call to a subscriber who is not located at their expected location. Thus, when a calling party attempts to contact a subscriber who is not at their expected location, the system initially leaves the call unanswered (i.e., ringing) while initiating one or more outgoing calls to call forwarding numbers for the subscriber. If no outgoing telephone call is answered, the system directs the incoming telephone call to the subscriber's voice mail, or to another pre-determined location (e.g., an attendant). On the other hand, if the outgoing telephone call is answered, the system answers the incoming telephone call and bridges the incoming to the answered outgoing call.

In one aspect of the present invention, there is provided a call handling method comprising: receiving an indication of an incoming call to a destination number (“DN”); and initiating an outgoing call to a plurality of forwarding numbers while leaving said incoming call unanswered.

In another aspect of the present invention, there is provided a method of redirecting an incoming telephone call from a calling party to a subscriber comprising: sensing said incoming telephone call; retrieving fowarding location information from a database; locating said subscriber based on said forwarding location information by initiating outgoing telephone calls to a plurality of forwarding locations; and answering and connecting said incoming telephone call to said subscriber, if said subscriber is located.

In accordance to a further aspect of the invention, there is provided a computer readable medium containing computer-executable instructions which, when performed by a processor in a telephone system, cause said processor to: receive an indication of an incoming call to a destination number (“DN”); and initiate an outgoing call to forwarding numbers while leaving said incoming call unanswered.

Other aspects and features of the present invention will become apparent to those ordinarily skilled in the art upon review of the following description of a specific embodiment of the invention in conjunction with the accompanying figures.

### BRIEF DESCRIPTION OF THE DRAWINGS

The following figures illustrate, by example only, embodiments of the invention:

FIG. 1 is a schematic diagram of a telecommunication system;

FIG. 2 is an example of forwarding location information table;

FIG. 3, comprised of FIGS. 3A and 3B, is a flowchart outlining a method according to the present invention; and

FIG. 4 is a flowchart outlining another method according to the present invention.

### DETAILED DESCRIPTION

The present invention is directed at a method for supervised call redirection for redirecting an incoming telephone call to a subscriber to a forwarding location when the subscriber is not at their expected location (e.g., their desk). When an incoming call is signalled at a telephone system which is local to the subscriber, the caller is presented with a ringing signal. Thus, the incoming call remains unanswered (i.e., the incoming call is not connected, nor is answer supervision returned to the switch from which the call originated). Meanwhile, using the DN from the incoming call, the system processor addresses a subscriber record in a database for call forwarding numbers associated with the subscriber. The processor then initiates an outgoing telephone call to each forwarding number for the subscriber. If, at any time, any one of the outgoing calls is answered, the processor answers the incoming call and bridges it with the answered outgoing call. In such case, the other outgoing calls are dropped. If none of the outgoing calls are answered after a pre-configured time, the incoming telephone call may be re-directed to a pre-determined location chosen by the subscriber. This location may be stored in the subscriber record and will typically be the location of a voice mail system for the subscriber or of an attendant. Optionally, the processor may restrict call forwarding based on the caller line identification (CLID) associated with the incoming call and/or may query the person answering an outgoing call as to whether that person wishes to take the incoming call before answering the incoming call and bridging it with the answered outgoing call. Optionally, the DN is associated with a subscriber line in which case an outgoing call may be initiated to that subscriber line while the subscriber record is retrieved and calls are placed to call forwarded numbers in the record.

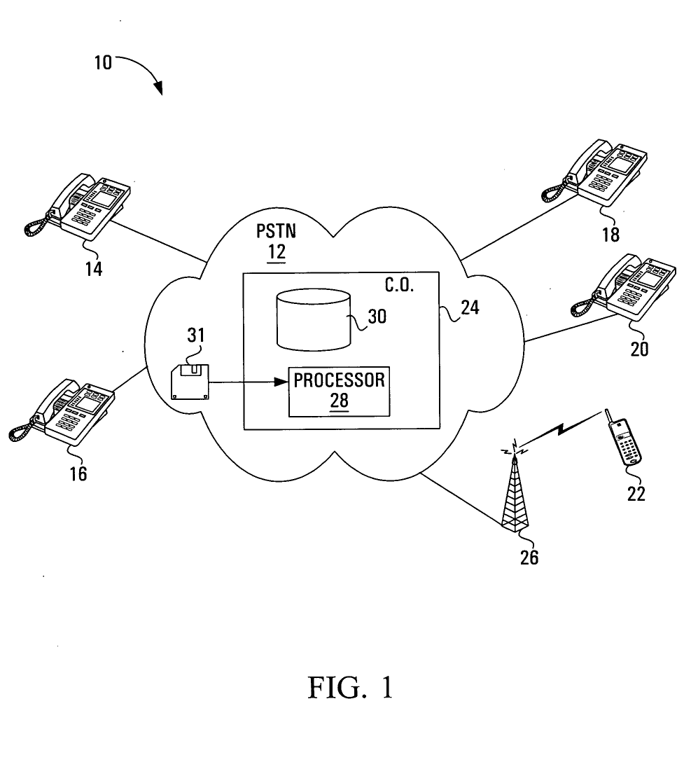

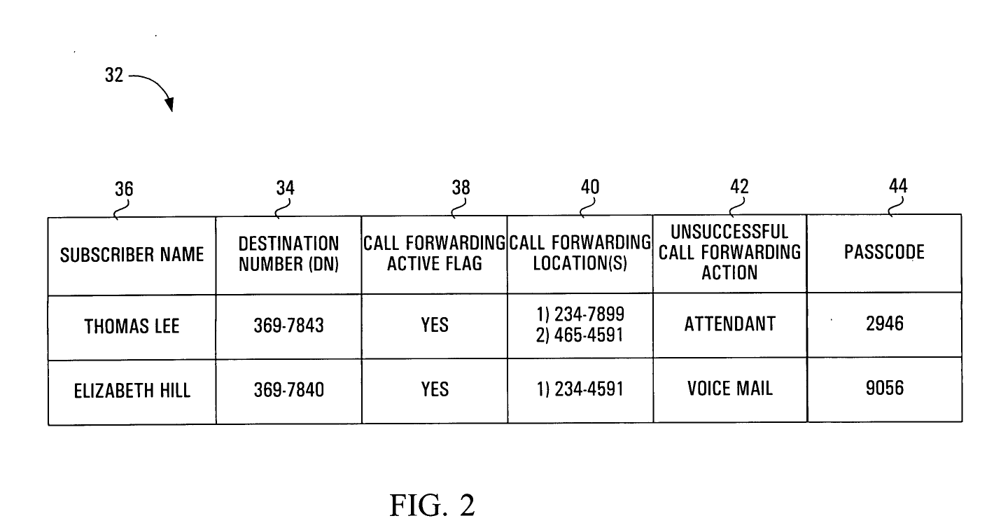

Turning to FIG. 1, a telecommunication system 10 comprises a public switched telephone network (PSTN) 12 which is connected to a number of telephony devices 14, 16, 18, 20, and 22. As shown, devices 14, 16, 18, and 20 are land line telephones and device 22 is a mobile telephone which connects to the PSTN through mobile base station 26. A central office (CO) 24 of PSTN 12 is local to telephony devices 18 and 20. The central office 24 has a processor 28 and a database 30. The processor is loaded with software adapting it to operate in accordance with this invention from computer medium 31. Medium 31 may be, for example, a diskette, CD-ROM, or a file downloaded from a remote source. Database 30 stores a subscriber record for each subscriber in a data structure. An example of the information which may be stored in the subscriber records is illustrated in FIG. 2. Turning to FIG. 2, the database may store in a record 32 for each subscriber: a destination number (DN) for the subscriber 34; the subscriber's name 36; a flag 38 indicating whether call forwarding is active; a list of forwarding numbers 40; an action to take when call forwarding is unsuccessful 42; and a passcode 44.

A subscriber may dial up a special access number at the CO 24, verify his identity in any suitable fashion and then change modifiable portions of his subscriber record. More particularly, the subscriber may change the list of call forwarding locations 40, the flag 38 in order to enable or disable call forwarding, and the action to be taken if call forwarding is unsuccessful. A menu driven user interface provided by the processor 28 at the central office may assist the subscriber in modifying his record.

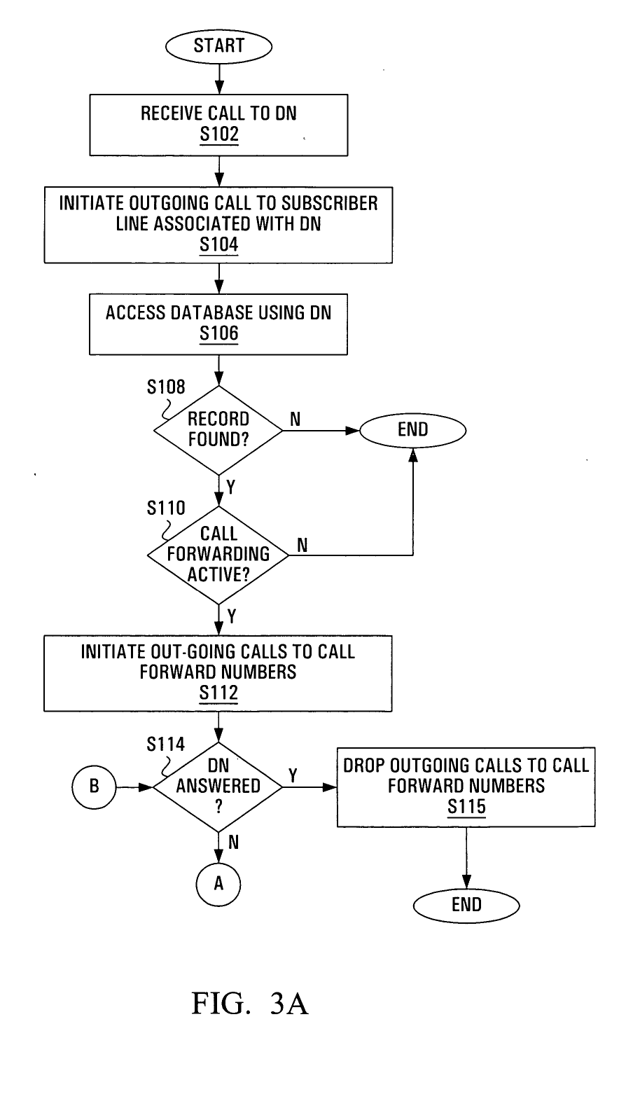

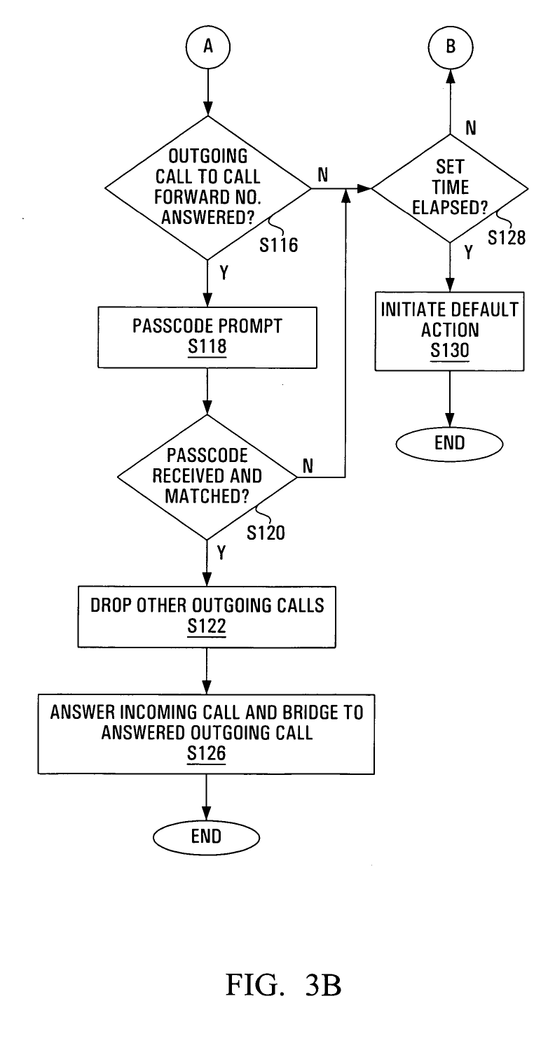

Turning to FIG. 3 along with FIGS. 1 and 2, in operation, on CO 24 receiving a call to a local DN (S102), if the DN is associated with a subscriber line, the processor 28 of the CO initiates an outgoing call to this subscriber line in a conventional manner (S104). Thus, the CO will send a ringing signal on this subscriber line, for example, the line terminated by telephone 18. In any event, the processor uses the DN as an index into database 30 (S106). If a subscriber record associated with the DN is found in database 30 (S108), the flag 38 is checked (S110). If call forwarding is active, the processor initiates, in parallel, outgoing calls to each call forwarding number in the subscriber record (S112), say telephone 20 and cellular phone 26. Optionally, the processor may be adapted to initiate these outgoing calls only after a pre-determined number of ringing signals have been sent to telephone 18. If, at any time, the outgoing call to telephone 18 is answered, the outgoing calls to call forwarding numbers are dropped (S114, S115). On the other hand, if a telephone associated with one of the call forwarding numbers is answered (S116), the processor presents a voice prompt asking the answering party to enter a passcode to receive the call (S118). If a passcode is received and it matches that found in the subscriber record for the DN (S120), the processor drops the calls to the other call forwarding numbers (S122) as well as to telephone 18 (S124). The processor then answers the incoming call and bridges the call with the answered outgoing call (S126). This establishes a call path from the calling party through to the answered call forwarding number.

If none of the outgoing calls are answered within a predetermined time, or if one or more of the outgoing calls to the call forwarded numbers are answered within the predetermined time but the correct passcode is not received from any of the answering parties (S128), then if the call to the DN has also remained unanswered, the processor accesses the subscriber record for the action 42 to be taken when call forwarding is unsuccessful and initiates this action (S130). In this way, the caller may be re-directed to the subscriber's voice mail, or to an attendant.

In another embodiment, a party answering an outgoing call at a call forwarded telephone receives a voice prompt from the processor identifying the intended subscriber and asking whether the answering party wishes to take the call. In this regard, the processor may simply ask the answering party to key in a certain number to indicate “yes” and another to indicate “no” If the entry indicates “yes”, the incoming call is answered at the CO and bridged to the answering party. If the entry indicates “no”, that outgoing call is dropped and the remaining outgoing calls continue for the duration of the pre-determined time. If the system has voice recognition then the caller may make a spoken reply to the query.

In a further embodiment, there is no requirement for a party answering an outgoing call at a call forwarded telephone to verify himself or request completion of the call. Instead, upon a party answering at a call forwarding number, the other outgoing calls are immediately dropped and the incoming call is answered at the CO and bridged to the answered call forwarded telephone. The disadvantage with this embodiment is that the call may be answered by someone other than a person to whom the caller wishes to speak.

Optionally, the subscriber record may also include a list of undesired calling numbers. If so, the processor compares the caller line identification (CLID) information associated with the calling party with this list. On a match, the processor makes no attempt to forward the call. Indeed, the subscriber record may include a field to indicate the preferred action on a call from an undesired calling party, such as immediate redirection to voice mail.

In a more sophisticated system, the list of call forwarding numbers in a subscriber record may be associated with days and times when they are valid such as is described in U.S. Pat. No. 5,329,578 to Brennan.

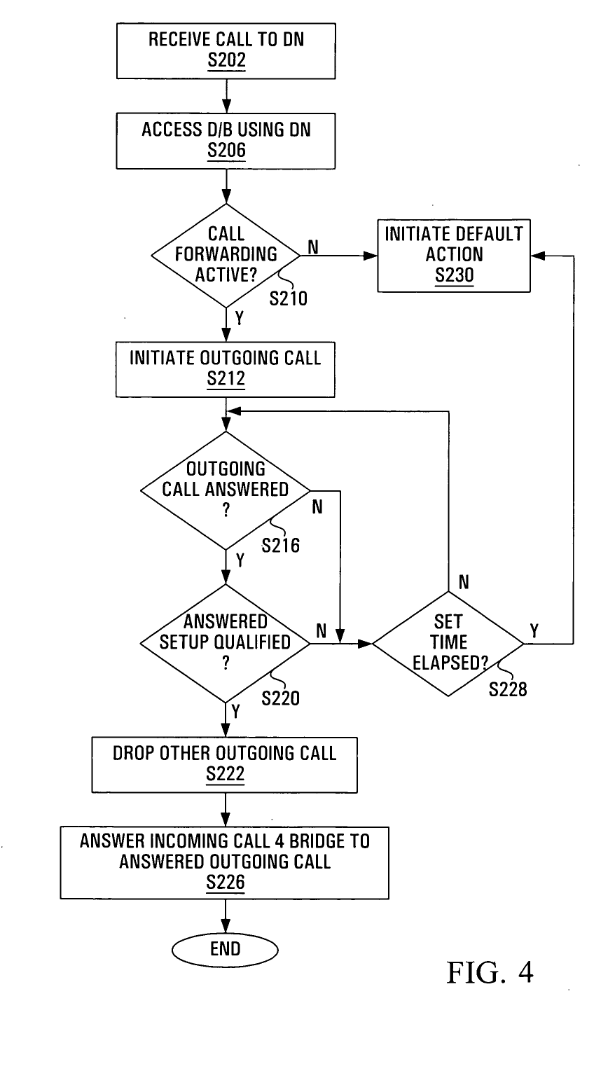

In another embodiment, the DN is not associated with a subscriber line, but solely with a subscriber record. This method according to this embodiment is described in conjunction with FIG. 4. Turning to FIG. 4 along with FIG. 1, after a call to a DN is received (S202), a corresponding subscriber record is located (S206). If the call forwarding flag in the record is set to active (S210), the processor 28 initiates outgoing calls to each call forwarding number indicated in the record (S212). If an outgoing call is answered (S216) and (optionally) the answering party qualifies himself (S220), the other outgoing calls are dropped (S222) and the incoming call is answered and bridged to the answering outgoing call (S226). If call forwarding is inactive, no-one answers an outgoing call within a pre-set time (S228), or no-one answers who is able to verify himself, a default action is taken (S230). As aforedescribed, this may mean connecting the caller to voice mail, or to an attendant.

In another embodiment, the described functionality is part of a PBX rather then being located at a CO.

Although the telecommunication system 10 has been shown including a PSTN, it will be understood that the method may also be used in an Internet Telephony system.

It will be understood that with the present invention, it is possible to arrange for the incoming telephone call not to be answered until the processor 28 has located the subscriber or has re-directed the call where call forwarding was unsuccessful (such as to the subscriber's voice messaging system or an attendant). In any event, the incoming call may be supervised at least until the earlier of the time it is answered by a person or a set time has elapsed.

The present invention provides the advantage of allowing incoming telephone calls to be supervised and redirected to a subscriber at a forwarding location without the calling party knowing that the call has been redirected. Furthermore, in the case of long distance calls, in many instances the calling party does not have to pay for the time to redirect the incoming telephone call since the incoming telephone call is left unanswered until an actual connection is made either with the subscriber at the forwarding location or in accordance with a predetermined option, such as the subscriber voice messaging system or an attendant.

The above-described embodiments are intended to be illustrative only, and in no way limiting. The embodiments are susceptible to many modifications of details and order of operation. The invention, rather, is intended to encompass all such modifications within its scope as defined by the claims.

1. A call handling method comprising:
receiving an indication of an incoming call to a destination number (“DN”) associated with a subscriber line;
initiating an outgoing call to said subscriber line;
accessing a database for a record corresponding to said DN;
determining, based upon information associated with said record, whether call forwarding is active; and
in response to determining that call forwarding is active, initiating one or more outgoing calls to one or more forwarding numbers while leaving said incoming call unanswered.

2. The method of claim 1 further comprising, in response to a one of said one or more outgoing calls being answered, bridging said incoming call with said answered outgoing call.

3. The method of claim 2 further comprising, prior to said bridging, qualifying a party answering said outgoing call as a party entitled to receive said incoming call.

4. (Canceled)

5. The method of claim 1 wherein said accessing said database further comprises locating said one or more forwarding numbers in said record.

6. The method of claim 5 further comprising, where none of said one or more outgoing calls is answered within a predetermined time, accessing said record for an action to take in respect of said incoming call.

7. The method of claim 6 wherein said action is forwarding to voice mail and, in response, forwarding said incoming call to voice mail.

8. The method of claim 3 wherein said qualifying comprises requesting an input from said party.

9. The method of claim 8 wherein said accessing said database further comprises locating said one or more forwarding numbers in said record, and wherein said input is compared with an entry in said record.

10. The method of claim 3 further comprising, where said party answering fails to qualify, bridging said incoming call with a voice mail box associated with said DN.

11. The method of claim 1 further comprising, where none of said one or more outgoing calls is answered within a predetermined time, bridging said incoming call with a voice mail box associated with said DN.

12. A method of redirecting an incoming telephone call from a calling party to a subscriber comprising:
sensing said incoming telephone call having a DN associated with a subscriber line of said subscriber;
initiating a first outgoing call to said subscriber line;
accessing a database for a record corresponding to said incoming telephone call;
determining, based upon information associated with said record, whether call forwarding is active, and in response to determination that call forwarding is active, retrieving forwarding location information from said database;
locating said subscriber by initiating one or more forwarding outgoing telephone calls to corresponding one or more forwarding locations; and
answering and connecting said incoming telephone call to said subscriber, if said subscriber answers a one of said first outgoing call to said subscriber line and said one or more forwarding outgoing telephone calls.

13. A computer readable medium comprising computer-executable instructions which, when performed by a processor in a telephone system, cause said processor to:
receive an indication of an incoming call to a destination number (“DN”) associated with a subscriber line;
initiating an outgoing call to said subscriber line;
access a database for a record corresponding to said DN;
determine, based upon information associated with said record, whether call forwarding is active; and
in response to determining that call forwarding is active, initiate one or more outgoing calls to one or more forwarding numbers while leaving said incoming call unanswered.

14. The medium of claim 13 comprising computer-executable instructions which, when performed by a processor in a telephone system, cause said processor to in response to a one of said one or more outgoing calls being answered, bridge said incoming call with said answered outgoing call.

15. The medium of claim 14 comprising computer-executable instructions which, when performed by a processor in a telephone system, cause said processor to: prior to causing said bridge, qualify a party answering said outgoing call as a party entitled to receive said incoming call.

16. (Canceled)

17. The medium of claim 13 comprising computer-executable instructions which, when performed by a processor in a telephone system, cause said processor to access said database and locate said one or more forwarding numbers in said record.

18. The medium of claim 17 comprising computer-executable instructions which, when performed by a processor in a telephone system, cause said processor to, where none of said one or more outgoing calls is answered within a predetermined time, access said record for an action to take in respect of said incoming call.

19. The medium of claim 18 wherein said action is forwarding to voice mail and, in response, forwarding said incoming call to voice mail.

20. The medium of claim 15 wherein said party is qualified by requesting an input from said party.

21. The medium of claim 20 wherein said one or more outgoing calls are initiated by accessing said database and locating said one or more forwarding numbers in said record and wherein said input is compared with an entry in said record.

22. The medium of claim 15 comprising computer-executable instructions which, when performed by a processor in a telephone system, cause said processor to, where said party answering fails to qualify, bridge said incoming call with a voice mail box associated with said DN.

23. The medium of claim 13 comprising computer-executable instructions which, when performed by a processor in a telephone system, cause said processor to, where none of said one or more outgoing calls is answered within a predetermined time, bridge said incoming call with a voice mail box associated with said DN.
